(19) United States
(12) Patent Application Publication
(10) Pub. No.: US 2021/0223039 A1
(43) Pub. Date: Jul. 22, 2021

(54) METHOD AND DEVICE FOR DETERMINING HEIGHT, ELECTRONIC DEVICE, AND COMPUTER-READABLE STORAGE MEDIUM

(71) Applicant: SZ DJI TECHNOLOGY CO., LTD., Shenzhen (CN)

(72) Inventors: Di GAO, Shenzhen (CN); Junxi WANG, Shenzhen (CN); Huangjian ZHU, Shenzhen (CN)

(21) Appl. No.: 17/204,906

(22) Filed: Mar. 17, 2021

Related U.S. Application Data
(63) Continuation of application No. PCT/CN2018/106191, filed on Sep. 18, 2018.

(51) Int. Cl. G01C 5/00

(52) U.S. Cl. CPC G01C 5/005

(57) ABSTRACT

Embodiments of the present disclosure provide a method for determining height. The method includes obtaining a plurality of reflection points within a predetermined angle range below an object to be detected; coordinating the plurality of reflection points; performing function fitting on the plurality of coordinated reflection points; determining a measured height of the object to be detected at a current time based on a function obtained by fitting; and weighting the measured height of the object to be detected at the current time and a predicted height of the object to be detected at the current time to determine an optimal estimated height of the object to be detected at the current time.

### CROSS-REFERENCE TO RELATED APPLICATION

This application is a continuation of International Application No. PCT/CN2018/106191, filed on Sep. 18, 2018, the entire content of which is incorporated herein by reference.

### TECHNICAL FIELD

The present disclosure relates to the technical field of radar measurement and, more specifically, to a height determination method, a distance determination method, a height determination device, a distance determination device, an electronic device, and a computer-readable storage medium.

### BACKGROUND

Altitude measurement of an aircraft is generally performed by sensor sensing signals, for example, the sensor can sense ultrasonic signals, optical signals, and air pressure signals.

However, the altitude measured by a sensor is easily affected by noise in the environment. For example, sensing ultrasonic waves can be easily affected by airflow and vibration, sensing optical signals (such as time-of-flight (TOF) ranging) can be easily affected by ambient light, and sensing air pressure can be easily affected by airflow.

In view of the above situations, the accuracy in measuring the altitude of an aircraft through the sensor is relative low.

### SUMMARY

One aspect of the present disclosure provides a method for determining height. The method includes obtaining a plurality of reflection points within a predetermined angle range below an object to be detected; coordinating the plurality of reflection points; performing function fitting on the plurality of coordinated reflection points; determining a measured height of the object to be detected at a current time based on a function obtained by fitting; and weighting the measured height of the object to be detected at the current time and a predicted height of the object to be detected at the current time to determine an optimal estimated height of the object to be detected at the current time.

Another aspect of the present disclosure provides a height determination system. The system includes a radar and a processor. The processor is configured to obtain a plurality of reflection points within a predetermined angle range, coordinate the plurality of reflection points; perform function fitting on the plurality of coordinated reflection points, determine a measured height of an object to be detected at a current time based on a function obtained by fitting, and weight the measured height of the object to be detected at the current time and a predicted height of the object to be detected at the current time to determine an optimal estimated height of the object to be detected at the current time.

Another aspect of the present disclosure provides a distance determination system. The system includes a radar and a processor. The processor is configured to obtain a plurality of reflection points within a predetermined angle range in a direction to be measured, coordinate the plurality of reflection points, perform function fitting on the plurality of coordinated reflection points, determine a measured distance of an object to be detected at a current time based on a function generated by fitting; and weight the measured distance of the object to be detected at the current time and a predicted distance of the object to be detected at the current time to determine an optimal estimated distance of the object to be detected at the current time.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a flowchart of a method for determining height according to an embodiment of the present disclosure.

FIG. 2 is a flowchart of a method for collecting a plurality of reflection points in a predetermined angle range below an object to be detected by radar according to an embodiment of the present disclosure.

FIG. 3 is a flowchart of another method for collecting a plurality of reflection points in the predetermined angle range below the object to be detected by radar according to an embodiment of the present disclosure.

FIG. 4 is a flowchart of a coordinated view of the plurality of reflection points according to an embodiment of the present disclosure.

FIG. 5 is a flowchart of another method for determining height according to an embodiment of the present disclosure.

FIG. 6 is a flowchart of a method for deleting outlier points with a clustering density is lower than a predetermined density from the plurality of reflection points according to an embodiment of the present disclosure.

FIG. 7 is a flowchart of a method for constructing a sliding clustering window in an empty two-dimensional matrix with the coordinates of the plurality of reflection points as elements according to an embodiment of the present disclosure.

FIG. 8 is a flowchart of a method for performing function fitting on the plurality of coordinated reflection points according to an embodiment of the present disclosure.

FIG. 9 is a flowchart of another method for determining height according to an embodiment of the present disclosure.

FIG. 10 is a flowchart of a method for calculating a measured height and a predicted height based on an estimation method according to an embodiment of the present disclosure.

FIG. 11 is a flowchart of a method for traversing the 2D matrix with a sliding window according to an embodiment of the present disclosure.

FIG. 12 is a schematic diagram of a sliding window to traverse the two-dimensional matrix according to an embodiment of the present disclosure.

FIG. 13 is a flowchart of another method for deleting the outlier points with a cluster density lower than the predetermined density from the plurality of reflection points according to an embodiment of the present disclosure.

FIG. 14 is a flowchart of the method for performing function fitting to the plurality of coordinated reflection points according to an embodiment of the present disclosure.

FIG. 15 is a flowchart of a method for determining the measured height of the object to be detected at a current time based on a function obtained by fitting according to an embodiment of the present disclosure.

FIG. 16 is a flowchart of a method for weighting the measured height of the object to be detected at the current time and the predicted height of the object to be detected at the current time to determine an optimal estimated height of the object to be detected at the current time according to an embodiment of the present disclosure.

FIG. 17 is a flowchart of a method for determining a predicted deviation corresponding to the predicted height of the object to be detected at the current time and a measurement noise of the measured height at the current time to determine a first weight of the predicted height at the current time and a second weight of the measured height at the current time according to an embodiment of the present disclosure.

FIG. 18 is a method for determining a distance according to an embodiment of the present disclosure.

### DETAILED DESCRIPTION OF THE EMBODIMENTS

In order to make the objectives, technical solutions, and advantages of the present disclosure more clear, the technical solutions in the embodiments of the present disclosure will be described below with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure. In addition, if there is no conflict, the following embodiments and features in the embodiments can be combined with each other.

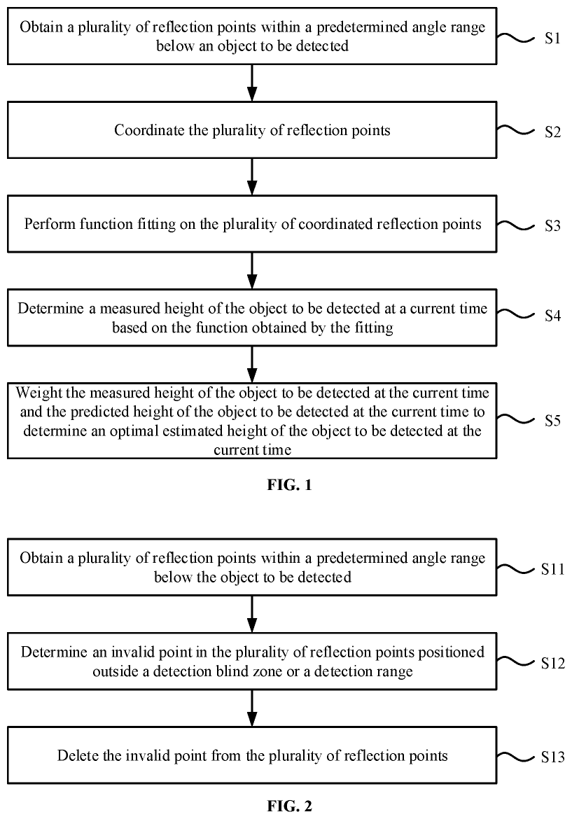

FIG. 1 is a flowchart of a method for determining height according to an embodiment of the present disclosure. The method can be applied to a vehicle such as an aircraft. In some embodiments, the aircraft can be an unmanned aerial vehicle (UAV) or a manned aerial vehicle. The method will be described in detail below.

S1, obtaining a plurality of reflection points within a predetermined angle range below an object to be detected.

In some embodiments, the object to be detected may be the aircraft or other objects positioned at the same height as the aircraft. The following description takes the object to be detected as the aircraft as an example to describe the embodiments of the present disclosure.

In some embodiments, a radar can be mounted on the aircraft, and the radar can obtain a plurality of reflection points within a predetermined angle range below the object to be detected through rotation. The predetermined angle range can be set as needed, for example, if the vertical position is 0°, the predetermined angle range may be −60° to +60°, that is, a range of 120° in total.

In some embodiments, the radar may obtain a reflection point every time it rotates through a predetermined angle. The reflection point may be a reflection point of an object positioned on the ground, such that the method of this embodiment can determine a predicted height of the object to be detected relative to the ground. The reflection point may also be an object below the ground or above the ground, as such, the method of this embodiment can determine the predicted height of the object to be detected relative to the object (in this case, the height may be understood as a distance). The embodiments of the present disclosure will be described below by taking the reflection point as a reflection point of an object positioned on the ground as an example.

After the radar receives the echo signal, it may perform signal processing, constant false alarm detection fusion, and other processing on the echo signal to extract a target signal of the reflection point from the clutter, noise, and various active and passive interference backgrounds. Subsequently, the target signal can be transmitted to a data recorder to record a distance L of the reflection point relative to the radar.

S2, coordinating the plurality of reflection points.

In some embodiments, a coordinate system can be constructed, such as a two-dimensional (2D) or a three-dimensional (3D) coordinate system. Take the 2D coordinate system as an example, the rotation angle of the radar can be calibrated through a grating disc. The rotation center of the radar can be used as the center of a circle, the direction directly below the object to be detected can be used as the y axis, and a certain direction in the horizontal plane (e.g., the forward direction of the aircraft) can be used as the x axis.

Based on the grating disc, the angle of the radar can be calculated. There may be a plurality of scales on the grating disc, and a light grid can be formed between two adjacent scales. The angle Z corresponding to each light grid may be the same. For example, the scale of the grating disc under the object to be detected may be G0. When the radar obtains a certain reflection point, the corresponding first scale on the grating disc may be G₁, and the angle that the radar is turned may be θ=(G1−G0)×Z.

Based on the angle that the radar has turned, the coordinates of the obtained reflection point i in the coordinate system can be determined, where the x-axis Xi=L×sin θ, and the y-axis coordinate Yi=L×cos θ.

S3, performing function fitting on the plurality of coordinated reflection points.

S4, determining a measured height of the object to be detected at a current time based on the function obtained by the fitting.

In some embodiments, function fitting can be performed for the coordinates of the plurality of reflection points obtained, where the function to be fitted can be determined based on needs, for example, it may be a linear function. After fitting the function, since all the reflection points are positioned on the function, and the reflection points correspond to the object to be detected, the fitted function can be equivalent to the ground. Take the linear function as an example, the ground can be substantially a plane. Subsequently, the distance from the origin of the coordinate system to the linear function can be calculated, which is the measured height Z(t) of the object to be detected at the current time t.

S5, weighting the measured height of the object to be detected at the current time and the predicted height of the object to be detected at the current time to determine an optimal estimated height of the object to be detected at the current time.

The method of determining the weight of the above weighting process will be described below.

Based on a predicted deviation corresponding to the predicted height of the object to be detected at the current time and the measurement noise of the measured height at the current time, a first weight of the predicted height at the current time and a second weight of the measured height at the current time can be determined. In some embodiments, the first weight may be negatively correlated with the prediction deviation, and the second weight may be negatively correlated with the measurement noise.

Subsequently, a weighted summation may be performed based on the predicted height and the first weight at the current time and the measured height and the second weight at the current time to determine the optimal estimated height of the object to be detected at the current time.

In some embodiments, the height of the object to be detected at the current time can be obtained by measurement, that is, the measured height Z(t) at the current time t. In addition, the height of the object to be detected at the current time can also be obtained by predicted the height of the object to be detected at a previous time, that is, the predicted height H(t|t−Δt) of the at the current time t, t−Δt being the previous time before the current time.

However, for the measured height Z(t), there may be a measurement noise R. For example, under ideal circumstances, the obtained reflection points are all points corresponding to the ground. However, in actual situation, there may be points that are not on the ground in the obtained reflection points, such as points corresponding to protrusions on the ground, and these points can be considered as measurement noise.

Correspondingly, for the predicted height H(t|t−Δt), there may be a prediction deviation P(t|t−Δt). The measurement deviation can be obtained based on an estimation deviation P(t−Δt|t−Δt) and the processing noise Q corresponding to an optimal estimated height H(t−Δt|t−Δt) of the object to be detected at the previous time t−Δt: P(t|t−Δt)=P(t−Δt|t−Δt)+Q. The above measurement noise R, prediction deviation P(t|t−Δt), estimation deviation P(t−Δt|t−Δt), and process noise Q can be expressed in the form of covariance.

Since both the measured height and the predicted height have a certain degree of inaccuracy, but both have a certain degree to confidence, in order to calculate the optimal estimated height of the object to be detected at the current time based on the measured height and the predicted height, the measured height and the predicted height can be weighted and summed. In some embodiments, the predicted can be weighted by the first weight1−G(t), and the measured height can be weighted by the second weight G(t), G(t) being a gain coefficient. As such, H(t|t)=H(t|t−Δt)(1−G(t))+G(t)Z(t)=H(t|t−Δt)+G(t)(Z(t)−H(t|t−Δt)). The first weight reflects the confidence of the predicted height, and the second weight reflects the confidence of the measured height. The optimal estimation height H(t|t) will be closer to the predicted height or the measured height with the higher confidence, that is, the higher the corresponding weight.

In some embodiments, the prediction deviation may reflect the confidence of the predicted height. The smaller the prediction deviation, the higher the confidence of the predicted height, that is the greater the first weight. Therefore, the first weight may be negatively correlated with the prediction deviation. Correspondingly, the second may be negatively correlated with the measurement noise. The measurement noise may reflect the confidence of the measured height. The smaller the measurement noise, the higher the confidence of the measured height, that is, the greater the second value. Therefore, the second weight may be negatively correlated with the measurement noise.

According to the embodiments of the present disclosure, by obtaining a plurality of reflection points, determining the corresponding coordinates, and performing function fitting, a function similar to the shape of the ground can be obtained, which can ensure that the deviation between the function corresponding to the actual ground and the function obtained by fitting is relative small. For example, fitting by the least squares method can ensure that the sum of squares of the deviation between the function corresponding to the actual ground and the function obtained by the fitting is minimal.

Further, by comprehensively considering the predicted height at the current time and the measured height at the current time, the weighted summation of the predicted height at the current time and the measured height at the current time can be used to obtain the optimal estimated height of the object to be detected at the current time. In some embodiments, the prediction deviation of the predicted height may be determined as the first weight for weighting the predicted height, and the measurement noise of the measured height may be determined as the second weight for weighting the measured height, thereby accurately determining the weight used for the weighted summation, and then accurately calculating the optimal estimated height at the current time.

For example, for the object to be detected, the above processes at S5 and S6 can be performed once at intervals of Δt, such as at a time t−Δt before the at the current time t. Based on the above processes, the optimal estimated height at time t−Δt may be H(t−Δt|t−Δt). Then take the movement model of the object to be detected as a constant velocity (CV) model as an example, the velocity of the object to be detected in the vertical direction may be vₜ, from which the predicted height of the object to be detected at the at the current time can be calculated as: H(t|t−Δt)=H(t−Δt t−Δt)+vₜΔt. There may be an error in the predicted height, which can be referred to as the prediction deviation and calculated as follow P(t|t−Δt)=P(t−Δt|t−Δt)+Q.

The prediction deviation P(t|t−Δt) is a deviation of the predicted height P(t|t−Δt) at the current time, which can be calculated by covariance. The estimation deviation P(t−Δt t−Δt) is an estimation of the deviation of H(t−Δt t−Δt), which can be calculated by covariance. Q is the process noise of the prediction model used, and the specific prediction model can be selected as needed.

Subsequently, Z(t) and H(t|t−Δt) can be calculated by using the optimal estimation method to determine the estimated height of the object to be detected at the current time as H(t|t)=H(t|t−Δt)+G(t)(Z(t)−H(t|t−Δt)), where the first weight is 1−G(t), the second weight is G(t), and G(t) can be calculated based on the prediction deviation P(t|t−Δt) and the measurement noise R as G(t)=P(t|t−Δt)/(P(t|t−Δt)+R). Based on this, the optimal estimate height H(t|t) at the current time t can be obtained.

For the above processes to continue until the object to be detected hits the ground, the perdition deviation P(t|t) of the H(t|t) can be updated as P(t|t)=(1−G(t))*P(t|t−Δt).

In some embodiments, since the jitter of the aircraft when hovering is at the centimeter level, the process noise Q can be set to 0.01 meter, and the prediction deviation P(0|0) at the initial time can be set to 0.

It should be noted that the execution frequency of the processes at S5 and S6 and the execution frequency of the processes at S1 to S4 may be different. For example, the execution frequency of the processes at S5 and S6 may be the same, such as 100 Hz, and the execution frequency of the processes at S1 to S4 may be the same, such as 15 Hz. That is, the frequency of determining the measured height may be less than the frequency of determining the optimal estimated height, such that before the new measured height is obtained, H(t|t−Δt) can be calculated. When the new measured height is determined, H(t|t) can be calculated.

FIG. 2 is a flowchart of a method for collecting a plurality of reflection points in a predetermined angle range below an object to be detected by radar according to an embodiment of the present disclosure. As shown in FIG. 2, obtaining the plurality of reflection points within the predetermined angle range below the object to be detected includes the following processes.

S11, obtaining a plurality of reflection points within a predetermined angle range below the object to be detected.

S12, determining an invalid point in the plurality of reflection points positioned outside a detection blind zone or a detection range.

S13, deleting the invalid point from the plurality of reflection points.

In some embodiments, when obtaining the reflection points by radar, some invalid points may be obtained due to environmental interference. These invalid points may be positioned in the detection blind zone of the radar, or positioned outside the detection range of the radar. These invalid points can be deleted from the plurality of reflection points to ensure that the subsequent determination of the measured height based on the coordinates of the measurement points can have a higher accuracy.

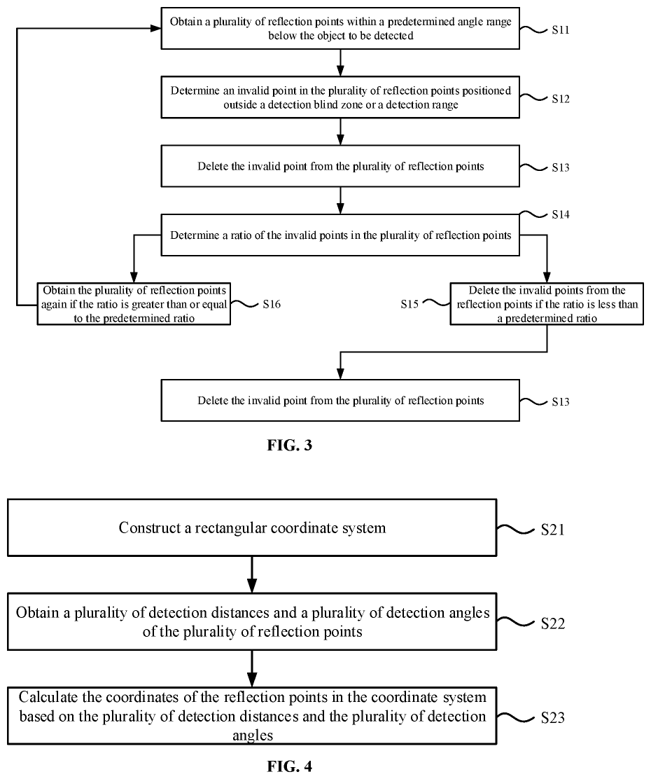

FIG. 3 is a flowchart of another method for collecting a plurality of reflection points in the predetermined angle range below the object to be detected by radar according to an embodiment of the present disclosure. As shown in FIG. 3, after determining the invalid points in the detection blind zone or outside the detection range in the plurality of reflection points, the method may further includes the following processes.

S14, determining a ratio of the invalid points in the plurality of reflection points.

S15, deleting the invalid points from the reflection points if the ratio is less than a predetermined ratio.

S16, obtaining the plurality of reflection points again if the ratio is greater than or equal to the predetermined ratio.

In some embodiments, if there are too many invalid points in the obtained reflection points, for example, the ratio of the invalid points in the reflection points is greater than or equal to the predetermined ratio, it may indicate that the radar received a lot of interference during this measurement, and the reflection points other than the invalid points in the reflection points may also likely be inaccurate. Therefore, the plurality of reflection points can be obtained again to ensure that the subsequent determination of the measured height based on the coordinates of the measurement points can have a higher accuracy.

FIG. 4 is a flowchart of a coordinated view of the plurality of reflection points according to an embodiment of the present disclosure. As shown in FIG. 4, coordinating the plurality of reflection points includes the following processes.

S21, constructing a rectangular coordinate system.

S22, obtaining a plurality of detection distances and a plurality of detection angles of the plurality of reflection points.

S23, calculating the coordinates of the reflection points in the coordinate system based on the plurality of detection distances and the plurality of detection angles.

In some embodiments, the radar that obtains the plurality of reflection points may be a rotating radar, and the plurality of reflection points may be obtained every time the radar rotates through a predetermined angle. For example, a rectangular coordinate system can be constructed with the position of the radar as the origin, and the detection angle when obtaining the reflection point i may be θ, the coordinate of the reflection point i along the x-axis in the coordinate system may be Xi=L×sin θ, and the coordinate along the y-axis may be Yi=L×cos θ.

For example, the radar may rotate in the grating disc. Based on the distance of the obtained reflection point, the first scale corresponding to the grating disc when the reflection point is obtained, the second scale of the grating disc below the object to be detected, and the angle corresponding to the optical grid of the grating disc can be obtained, and the coordinates of the reflection point in the rectangular coordinate system can be determined.

In some embodiments, the radar rotation point can be used as the center of the circle, the direction directly below the object to be detected can be used as the y-axis, and a certain direction in the horizontal plane (e.g., the forward direction of the aircraft) can be used as the x-axis.

Based on the grating disc, the angle of the radar can be calibrated. There may be a plurality of scales on the grating disc, and a light grid can be formed between two adjacent scales. The angle Z corresponding to each light grid may be the same. For example, the scale of the grating disc under the object to be detected may be G0. When the radar obtains a certain reflection point, the corresponding first scale on the grating disc may be G1, and the angle that the radar is turned may be θ=(G1−G0)×Z.

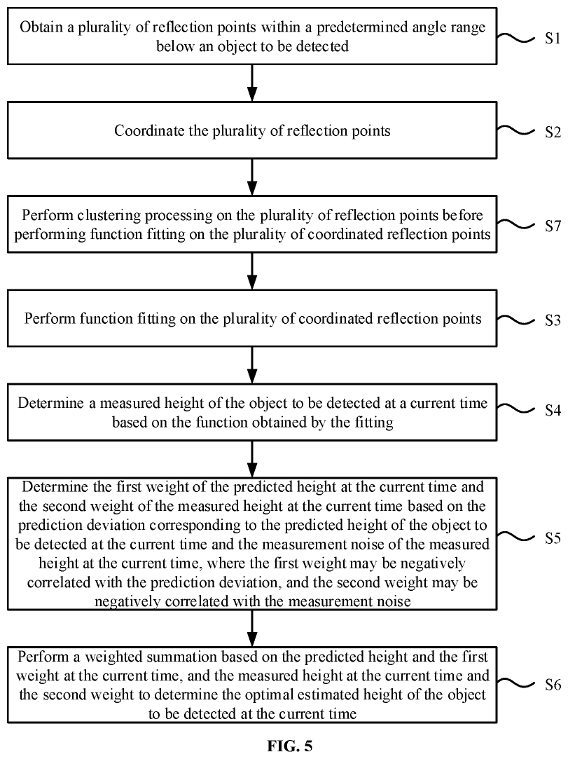

FIG. 5 is a flowchart of another method for determining height according to an embodiment of the present disclosure. As shown in FIG. 5, the method further includes the following process.

S7, performing clustering processing on the plurality of reflection points before performing function fitting on the plurality of coordinated reflection points.

In some embodiments, due to environmental factors, or the presence of debris on the ground, etc., although the measurement points are within the radar detection range and not in the radar detection blind zone, there may be measurement points that do not belong to the corresponding points on the ground. For example, the ground is generally continuous, therefore, the plurality of reflection points corresponding to the ground should also be continuous. When a flagpole or other protruding object is inserted on the ground, reflection points far away from the ground will be obtained. These points are outliers, which will affect the accuracy of the function fitting.

In the actual environment, there may not be many objects that protrude or sink into the ground. Therefore, the density of such outliers is often lower than the corresponding points on the ground. In this way, the reflection points can be clustered to delete outliers whose clustering density is lower than a predetermined density from the plurality of reflection points, thereby ensuring that the subsequent function fitting based on the coordinates of the measurement points can have a higher accuracy.

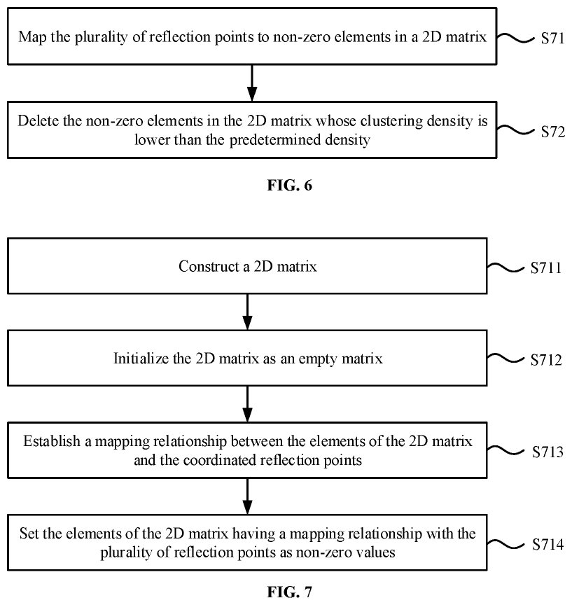

FIG. 6 is a flowchart of a method for deleting outlier points with a clustering density is lower than a predetermined density from the plurality of reflection points according to an embodiment of the present disclosure. As shown in FIG. 6, the clustering processing of the plurality of reflection points can include the following processes.

S71, mapping the plurality of reflection points to non-zero elements in a 2D matrix.

S72, deleting the non-zero elements in the 2D matrix whose clustering density is lower than the predetermined density.

In some embodiments, the plurality of reflection points can be used to construct a 2D matrix based on distance. The plurality of reflection points can be first mapped to a 2D matrix, such as mapping the coordinates of the plurality of reflection points to an empty 2D matrix, where the element mapped with the reflection point becomes a non-zero element. Subsequently, based on the density, the non-zero element sin the 2D matrix whose clustering density is lower than the predetermined density can be determined, that is, the reflection points with lower clustering density among the plurality of reflection points, such that only the non-zero elements with higher clustering density will be retained. That is, the reflection points with higher clustering density can be retained and the outliers can be deleted.

FIG. 7 is a flowchart of a method for constructing a sliding clustering window in an empty 2D matrix with the coordinates of the plurality of reflection points as elements according to an embodiment of the present disclosure. As shown in FIG. 7, mapping the plurality of reflection points into non-zero elements in a 2D matrix can include the following processes.

S711, constructing a 2D matrix.

S712, initializing the 2D matrix as an empty matrix.

S713, establishing a mapping relationship between the elements of the 2D matrix and the coordinated reflection points.

S714, setting the elements of the 2D matrix having a mapping relationship with the plurality of reflection points as non-zero values.

In some embodiments, a 2D matrix can be constructed based on the maximum detection distance of the radar (where the maximum detection distance along the x-axis direction may be Lₕ, and the maximum detection distance along the y-axis direction may be Lᵥ) and a resolution r when the reflection point is obtained. Further, the 2D matrix can be initialized as an empty matrix.

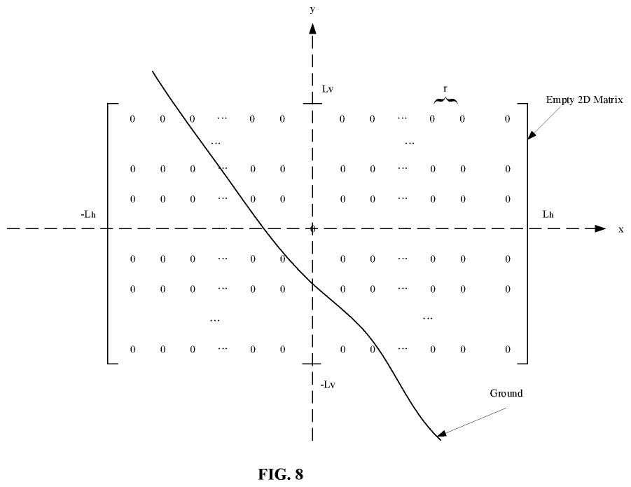

FIG. 8 is a flowchart of a method for performing function fitting on the plurality of coordinated reflection points according to an embodiment of the present disclosure.

As shown in FIG. 8, the coordinate system is the coordinate system where the reflection points are positioned. The detection range of the radar along the x-axis is −Lₕ, to +Lₕ, and the detection along the y-axis is −Lᵥ to +Lᵥ. Then the 2D empty matrix can correspond to the x-axis coordinates range from −Lh to +Lh, in the row direction, and the y-axis coordinates range from −Lv to +Lv in the column direction, where the distance between adjacent elements is the resolution r.

Subsequently, an empty 2D matrix of

$$\frac{2 {L}_{h}}{r} \times \frac{2 {L}_{v}}{r}$$

can be obtained. Based on this, coordinates corresponding to the reflection points that may be obtained can be mapped to the empty 2D matrix. For example the coordinates (xᵢ,yᵢ) corresponding to the reflection point i can be mapped to the above empty 2D matrix as a matrix element (Iᵢ,Jᵢ) in the empty 2D matrix, where

$${I}_{i} = \frac{{x}_{i} + {L}_{h}}{r} and {J}_{i} = \frac{{y}_{i} + {L}_{v}}{r} .$$

For example, the shape of the ground in the coordinate system may be as shown in FIG. 8. Since the reflection point should be a point on the ground, the corresponding non-zero element in the matrix of the reflection point mapped to the empty 2D matrix can correspond to the element that the ground passes through in the 2D matrix.

FIG. 9 is a flowchart of another method for determining height according to an embodiment of the present disclosure.

As shown in FIG. 9. In one example, the elements of a 2D matrix having a mapping relationship with the plurality of reflection points are set to non-zero values, where the non-zero values are set to 1. Then the elements with the value of 1 in the 2D matrix are shown in FIG. 9. These non-zero elements can be approximately by the elements of the ground shape passing through the 2D matrix.

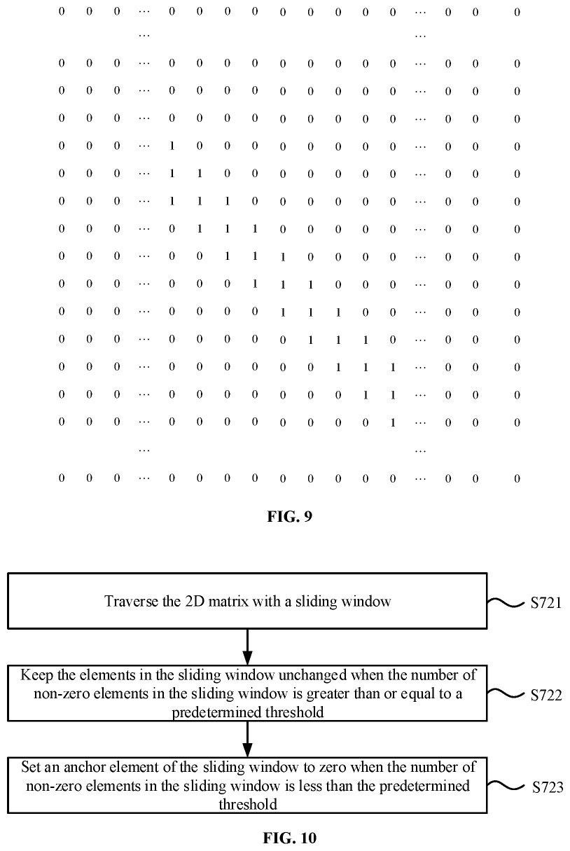

FIG. 10 is a flowchart of a method for calculating a measured height and a predicted height based on an estimation method according to an embodiment of the present disclosure. As shown in FIG. 10, deleting the non-zero elements in the 2D whose clustering density is lower than the predetermined density can include the following processes.

S721, traversing the 2D matrix with a sliding window.

S722, keeping the elements in the sliding window unchanged when the number of non-zero elements in the sliding window is greater than or equal to a predetermined threshold.

S723, setting an anchor element of the sliding window to zero when the number of non-zero elements in the sliding window is less than the predetermined threshold.

In some embodiments, after the reflection points are mapped to an empty 2D matrix, the elements mapped to the reflection points may have a non-zero value, and the elements that are not mapped to the reflection points may have a corresponding value of zero, that is, the elements with a non-zero value and the reflection points may have a one-to-one correspondence. Therefore, the density of the non-zero elements may reflect the density of the reflection points. In order to determine the density of the non-zero elements, a sliding window can be constructed, and the sliding the sliding can be slide in the matrix to traverse the 2D matrix.

The size and shape of the sliding window can be set as needed. For example, the shape of the sliding may be set to a rectangle, a circle, or a triangle. Take a rectangle as an example, the size of the sliding window can be 3×3, 4×4, 3×4, etc. The predetermined threshold can be set based on a number of element n that can be included in the sliding window. For example, n may be an odd number, and the predetermined threshold may be (n+1)/2. In another example, n may be an even number, and the predetermined threshold may be n/2.

Based on the relationship between the number of non-zero elements in the sliding window and the predetermined threshold, whether the density of the non-zero element is low can be determined. For example, if the number of non-zero elements in the sliding window is less than the predetermined threshold, the density of the non-zero elements can be determined as low. That is, the density of the reflection points corresponding to the non-zero elements is low, such that the anchor point elements in the sliding window can be set to zero, such that only the non-zero elements with a higher clustering density can be retained. That is, the reflection points with higher clustering density can be retained to realize the deletion of the outliers.

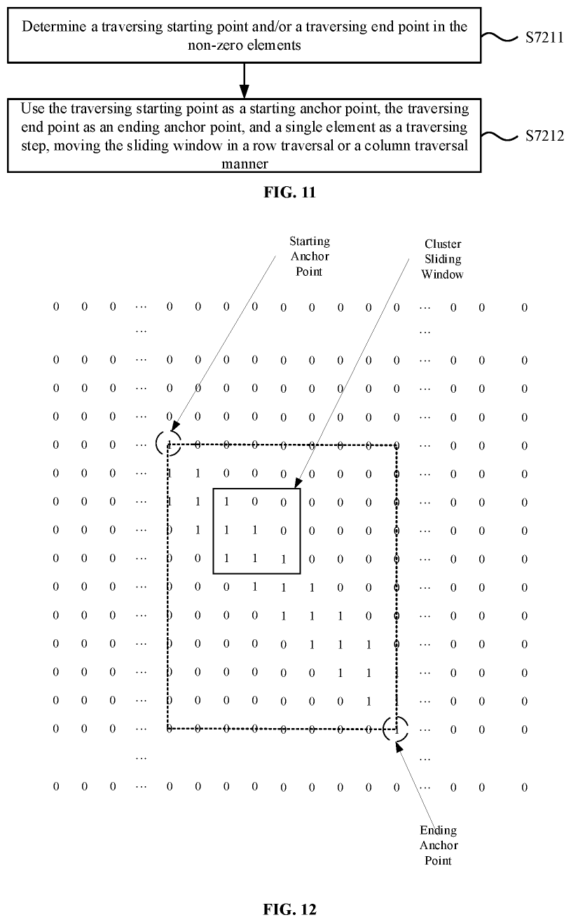

FIG. 11 is a flowchart of a method for traversing the 2D matrix with a sliding window according to an embodiment of the present disclosure. As shown in FIG. 11, traversing the 2D matrix with a sliding window can include the following processes.

S7211, determining a traversing starting point and/or a traversing end point in the non-zero elements.

S7212, using the traversing starting point as a starting anchor point, the traversing end point as an ending anchor point, and a single element as a traversing step, moving the sliding window in a row traversal or a column traversal manner.

In the 2D matrix, the elements mapped to the reflection points are the non-zero elements, and elements not mapped to the reflection points are zero elements, and these zero element may not correspond to the reflection points. Therefore, traversing these zero elements may cause a situation where all the elements in the sliding window are zero elements. In this situation, the sliding window does not include any reflection points, which does not get involved in determining the density of the reflection points, such that the sliding operation is wasted.

In some embodiments, the traversing starting point and/or the traversing ending point can be determined in the non-zero elements. In some embodiments, only the traversing starting point may be determined, or only the traversing ending point may be determined, or both the traversing starting point and the traversing ending point may be determined.

FIG. 12 is a schematic diagram of a sliding window to traverse the two-dimensional matrix according to an embodiment of the present disclosure.

As shown in FIG. 12, the traversing starting point and the traversing ending point can be determined in the non-zero elements. Then the sliding window can slide in the rectangular area with the traversing starting point and the traversing ending point as the diagonal points (as shown in the doted area in FIG. 12), such that only the points in the rectangular area and on the sides of the rectangular area can be traversed by the sliding window. Since the reflection points corresponding to the non-zero elements are mostly points corresponding to the ground, and the ground is continuous, that is, the reflection points are continuous, the non-zero elements are also continuous. Therefore, most of the points between two non-zero elements may also be non-zero elements.

Therefore, setting the starting and ending anchor points of the sliding window can make the sliding window slide in an area with more non-zero elements, thereby reducing the situation where all elements in the sliding window are zero elements, making the operation of sliding the sliding window can effectively determine the clustering density of the reflection points, and reduce the waste of resources in the sliding operation.

For example, for matrix index numbers corresponding to the non-zero elements in the 2D matrix, the smallest index number (Iₘᵢₙ,Jₘᵢₙ) and the largest index number (Iₘₐₓ,Jₘₐₓ) can be determined. The smallest index number can be used as the starting anchor point and the largest index number can be used as the ending anchor point to slide the sliding window.

In some embodiments, determining the traversing starting point and/or the traversing ending point in the non-zero elements may include determining an element with the smallest sum of rows and columns of the non-zero elements in the 2D matrix as the traversing starting point; or, determining the element with the smallest sum of the number of rows and columns of the non-zero elements in the 2D matrix as the traversing ending point.

In some embodiments, determining the traversing starting point and/or the traversing ending point in the non-zero elements may include determining an element with the largest sum of rows and columns of the non-zero elements in the 2D matrix as the traversing starting point; or, determining the element with the largest sum of the number of rows and columns of the non-zero elements in the 2D matrix as the traversing ending point.

In some embodiments, the method of determining the traversing starting point and the traversing ending point in the non-zero elements may be selected based on needs. For example, the element with the smallest sum of rows and columns of the non-zero elements can be determined as the traversing starting point, or the element with the smallest sum of rows and columns of the non-zero elements can be determined as the traversing ending point. Alternatively, the element with the largest sum of rows and columns of the non-zero elements can be determined as the traversing starting point, or the element with the largest sum of rows and columns of the non-zero elements can be determined as the traversing ending point.

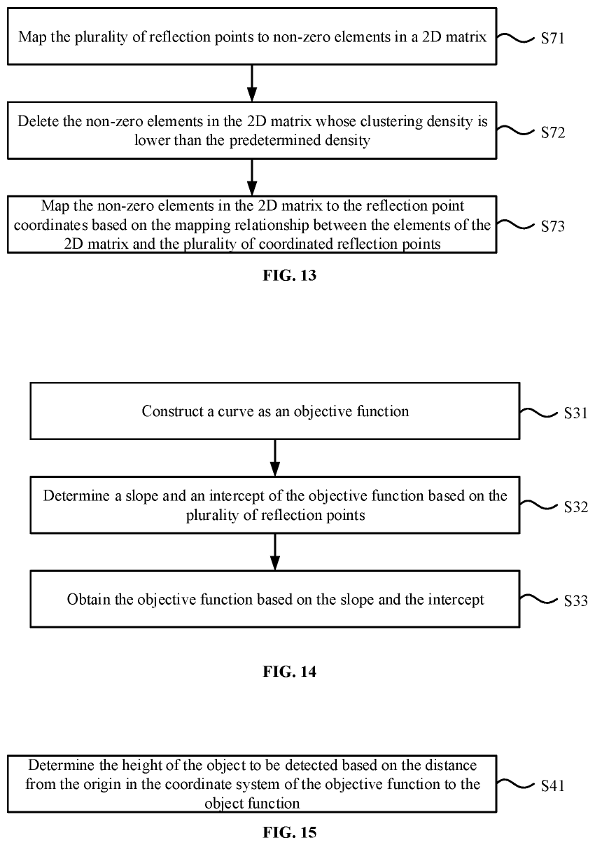

FIG. 13 is a flowchart of another method for deleting the outlier points with a cluster density lower than the predetermined density from the plurality of reflection points according to an embodiment of the present disclosure. As shown in FIG. 13, after deleting the non-zero elements in the 2D matrix whose clustering density is lower than the predetermined threshold, the method can further include the following process.

S73, mapping the non-zero elements in the 2D matrix to the reflection point coordinates based on the mapping relationship between the elements of the 2D matrix and the plurality of coordinated reflection points.

In some embodiments, after deleting the non-zero elements with clustering density lower than the predetermined density in the 2D matrix, the remaining reflection points may be still in the form of elements in the matrix, which is not convenient for subsequent function fitting, therefore, the remaining non-zero elements in the 2D matrix can be mapped to the reflection point coordinates, such that the remaining reflection points can be expressed in the form of coordinates to facilitate the subsequent function fitting.

FIG. 14 is a flowchart of the method for performing function fitting to the plurality of coordinated reflection points according to an embodiment of the present disclosure. As shown in FIG. 14, performing function fitting of the plurality of coordinated reflection points may include the following processes.

S31, constructing a curve as an objective function.

S32, determining a slope and an intercept of the objective function based on the plurality of reflection points.

S33, obtaining the objective function based on the slope and the intercept.

In some embodiments, a curve y=kx+b can be constructed as the objective function. Based on the plurality of (e.g., n, where n≥1) reflection points (x₁,y₁) (x₂,y₂) (xₙ,yₙ), the slope k and the intercept b of the above objective function can be determined. For example, the slope k and the intercept b may be determined based on the Cramer's law, where

$$k = \frac{n \sum {x}_{i} {y}_{i} - \sum {x}_{i} \sum {y}_{i}}{n \sum {x}_{i}^{2} - {( \sum {x}_{i} )}^{2}} and b = \frac{\sum {x}_{i}^{2} \sum {y}_{i} - \sum {x}_{i} \sum {x}_{i} {y}_{i}}{n \sum {x}_{i}^{2} - {( \sum {x}_{i} )}^{2}} .$$

Based on this, the function after fitting can be determined.

FIG. 15 is a flowchart of a method for determining the measured height of the object to be detected at a current time based on a function obtained by fitting according to an embodiment of the present disclosure. As shown in FIG. 15, determining the measured height of the object to be detected at the current time based on the function obtained by fitting may include the following process.

S41, determining the height of the object to be detected based on the distance from the origin in the coordinate system of the objective function to the object function.

In some embodiments, since the objective function obtained by fitting may be the function of the reflection points on the ground, the corresponding line of the function in the coordinate system can be understood as the ground. Therefore, by calculating the distance from the origin of the coordinate system to the objective function, the height of the object to be detected to the ground can be determined.

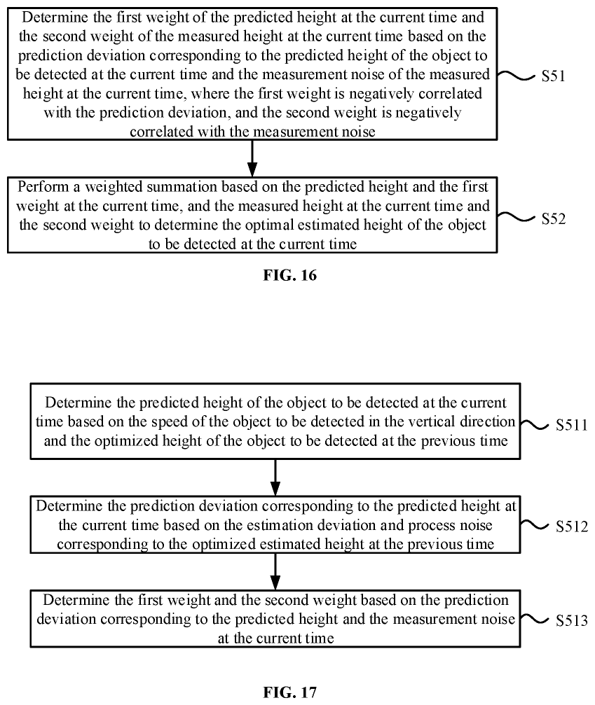

FIG. 16 is a flowchart of a method for weighting the measured height of the object to be detected at the current time and the predicted height of the object to be detected at the current time to determine an optimal estimated height of the object to be detected at the current time according to an embodiment of the present disclosure. As shown in FIG. 16, weighting the measured height of the object to be detected at the current time and the predicted height of the object to be detected at the current time to determine the optimal estimated height of the object to be detected at the current time can include the following processes.

S51, determining the first weight of the predicted height at the current time and the second weight of the measured height at the current time based on the prediction deviation corresponding to the predicted height of the object to be detected at the current time and the measurement noise of the measured height at the current time. In some embodiments, the first weight may be negatively correlated with the prediction deviation, and the second weight may be negatively correlated with the measurement noise.

S52, performing a weighted summation based on the predicted height and the first weight at the current time, and the measured height at the current time and the second weight to determine the optimal estimated height of the object to be detected at the current time.

FIG. 17 is a flowchart of a method for determining a predicted deviation corresponding to the predicted height of the object to be detected at the current time and a measurement noise of the measured height at the current time to determine a first weight of the predicted height at the current time and a second weight of the measured height at the current time according to an embodiment of the present disclosure. As shown in FIG. 17, determining the predicted deviation corresponding to the predicted height of the object to be detected at the current time and the measurement noise of the measured height at the current time to determine the first weight of the predicted height at the current time and the second weight of the measured height at the current time can include the following processes.

S511, determining the predicted height of the object to be detected at the current time based on the speed of the object to be detected in the vertical direction and the optimal height of the object to be detected at the previous time.

S512, determining the prediction deviation corresponding to the predicted height at the current time based on the estimation deviation and process noise corresponding to the optimal estimated height at the previous time.

S513, determining the first weight and the second weight based on the prediction deviation corresponding to the predicted height and the measurement noise at the current time.

In some embodiments, take the movement model of the object to be detected as a constant velocity (CV) model as an example, assume the height of the object to be detected at time t is Hₜ, the speed is vₜ, then the height Hₜ₊₁ and the speed vₜ₊₁ of the object to be detected at time t+1 may be Hₜ₊₁=Hₜ+vₜΔt+μΔt²/2 and vₜ₊₁=vₜ+μΔt, respectively, where Δt can be 0.01 second.

Since the measured height may include a measurement noise R during the measurement process, R can be the Gaussian white noise with a mean value of 0 and a variance of δ², then the measured height at the at the current time t can be determined through the formula of

$$Z ( t ) = {H}_{i} + R = [ 1 \; 0 ] [ \begin{matrix}{H}_{t} \\ {v}_{t}\end{matrix} ] + R .$$

Based on the CV model, the height of the object to be detected at the next time can be predicted. For example, for the object to be detected, the above processes can be performed at intervals of Δt. For example, at a time Δt−t before the current time t, the optimal estimated height H(t−Δt|t−Δt) can be determined based on the above processes. Then take the movement model of the object to be detected as a constant velocity (CV) model as an example, the velocity of the object to be detected in the vertical direction may be vₜ, from which the predicted height of the object to be detected at the at the current time can be calculated as: H(t|t−Δt)=H(t−Δt|t−Δt)+vₜΔt. There may be an error in the predicted height, which can be referred to as the prediction deviation and calculated as P(t|t−Δt)=P(t−Δt t−Δt)+Q.

The prediction deviation P(t|t−Δt) is a deviation of the predicted height P(t|t−Δt) at the current time, which can be calculated by covariance. The estimation deviation P(t−Δt|t−Δt) is an estimation of the deviation of H(t−Δt|t−Δt), which can be calculated by covariance. Q is the process noise of the prediction model used, and the specific prediction model can be selected as needed.

Subsequently, Z(t) and H(t|t−Δt) can be calculated by using the optimal estimation method to eliminate the measurement deviation caused by various factors in the measurement process, thereby determining the estimated height of the object to be detected at the current time as H(t|t)=H(t|t−Δt)(1−G(t))+G(t)Z(t)=H(t|t−Δt)+G(t)(Z(t)−H(t|t−Δt)), where the first weight is 1−G(t), the second weight is G(t), and G(t) can be calculated based on the prediction deviation P(t|t−Δt) and the measurement noise R as G(t)=P(t|t−Δt)/(P(t|t−Δt)+R). Based on this, the optimal estimated height H(t|t) for the current time t can be obtained.

For the above processes to continue until the object to be detected hits the ground, the perdition deviation P(t|t) of the H(t|t) can be updated as P(t|t)=(1−G(t))*P(t|t−Δt).

It should be noted that the foregoing process can be understood as a recursive filtering (automatic regression filter) process, and the specific algorithm is not limited to the description of the foregoing embodiment, and can be adjusted based on needs and actual conditions.

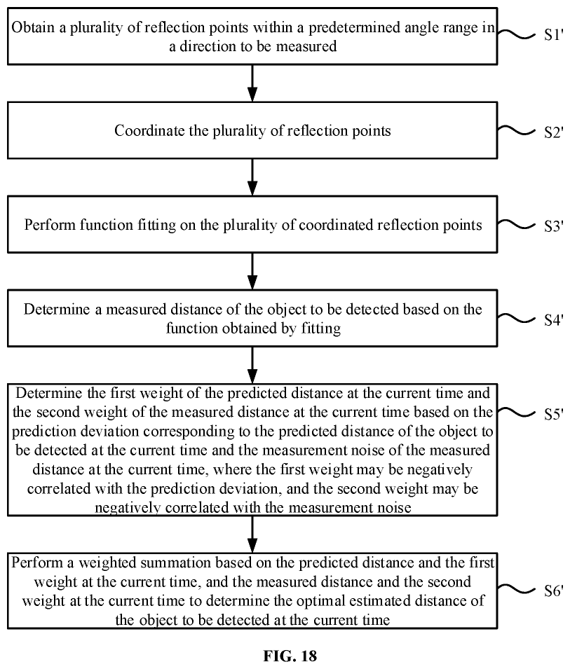

FIG. 18 is a method for determining a distance according to an embodiment of the present disclosure. As shown in FIG. 18, the method for determining a distance can include the following processes.

S1′, obtaining a plurality of reflection points within a predetermined angle range in a direction to be measured.

S2′, coordinating the plurality of reflection points.

S3′, performing function fitting on the plurality of coordinated reflection points.

S4′, determining a measured distance of the object to be detected based on the function obtained by fitting.

S5′, weighting the measured distance of the object to be detected at the current time and a predicted distance of the object to be detected at the current time to determine an optimal estimated distance of the object to be detected at the current time.

Different from the embodiment shown in FIG. 1, the reflection points obtained in this embodiment can be positioned within the predetermined angle range in the direction to be measured, that is, the reflection points can be positioned in front of the object to be detected, behind the object to be detected, or positioned above the object to be detected.

The subsequent process of calculating the optimal estimated distance may be similar to the process of calculating the optimal estimated height in the embodiment shown in FIG. 1. However, determining the predicted distance may need to be based on the projection speed in the distance measuring direction.

For example, the distance measuring direction may be the forward direction, then the first curve obtained by fitting may correspond to a wall surface, and the calculated measured distance may be the distance between the object to be detected and the wall surface. The final optimal estimated distance may be the distance between the object to be detected and the wall.

Corresponding to the above embodiments of the height determination method and the distance determination method, the present disclosure further provides embodiments of the corresponding system, computer-readable storage medium, device, and unmanned aerial vehicle (UAV).

An embodiment of the present disclosure further provides a height determination device including a radar and a processor. The processor may be configured to obtain a plurality of reflection points within a predetermined angle range below an object to be detected; coordinate the plurality of reflection points; perform function fitting on the plurality of coordinated reflection points; determine a measured height of the object to be detected at a current time based on the function obtained by the fitting; and weight the measured height of the object to be detected at the current time and the predicted height of the object to be detected at the current time to determine an optimal estimated height of the object to be detected at the current time.

In some embodiments, the processor may be configured to obtain a plurality of reflection points within a predetermined angle range below the object to be detected; determine an invalid point in the plurality of reflection points positioned outside a detection blind zone or a detection range; and delete the invalid point from the plurality of reflection points.

In some embodiments, the processor may be configured to determine a ratio of the invalid points in the plurality of reflection points; delete the invalid points from the reflection points if the ratio is less than a predetermined ratio; and obtain the plurality of reflection points again if the ratio is greater than or equal to the predetermined ratio.

In some embodiments, the processor may be configured to construct a rectangular coordinate system; obtain a plurality of detection distances and a plurality of detection angles of the plurality of reflection points, where the detection angles can be determined based on the rotation angles when the radar obtains the reflection points; and calculate the coordinates of the reflection points in the coordinate system based on the plurality of detection distances and the plurality of detection angles.

In some embodiments, the processor may be configured to perform clustering processing on the plurality of reflection points before performing function fitting on the plurality of coordinated reflection points.

In some embodiments, the processor may be configured to map the plurality of reflection points to non-zero elements in a 2D matrix; and delete the non-zero elements in the 2D matrix whose clustering density is lower than the predetermined density.

In some embodiments, the processor may be configured to construct a 2D matrix; initialize the 2D matrix as an empty matrix; establish a mapping relationship between the elements of the 2D matrix and the coordinated reflection points; and set the elements of the 2D matrix having a mapping relationship with the plurality of reflection points as non-zero values.

In some embodiments, the processor may be configured to traverse the 2D matrix with a sliding window; keep the elements in the sliding window unchanged when the number of non-zero elements in the sliding window is greater than or equal to a predetermined threshold; and set an anchor element of the sliding window to zero when the number of non-zero elements in the sliding window is less than the predetermined threshold.

In some embodiments, the processor may be configured to determine a traversing starting point and/or a traversing end point in the non-zero elements; and use the traversing starting point as a starting anchor point, the traversing end point as an ending anchor point, and a single element as a traversing step, moving the sliding window in a row traversal or a column traversal manner.

In some embodiments, the processor may be configured to determine an element with the smallest sum of rows and columns of the non-zero elements in the 2D matrix as the traversing starting point; or, determine the element with the smallest sum of the number of rows and columns of the non-zero elements in the 2D matrix as the traversing ending point.

In some embodiments, the processor may be configured to determine an element with the largest sum of rows and columns of the non-zero elements in the 2D matrix as the traversing starting point; or, determine the element with the largest sum of the number of rows and columns of the non-zero elements in the 2D matrix as the traversing ending point.

In some embodiments, the processor may be configured to map the non-zero elements in the 2D matrix to the reflection point coordinates based on the mapping relationship between the elements of the 2D matrix and the plurality of coordinated reflection points after deleting the non-zero elements in the 2D matrix whose clustering density is lower than the predetermined threshold.

In some embodiments, the processor may be configured to construct a curve as an objective function; determine a slope and an intercept of the objective function based on the plurality of reflection points; and obtain the objective function based on the slope and the intercept.

In some embodiments, the processor may be configured to determine the height of the object to be detected based on the distance from the origin in the coordinate system of the objective function to the object function.

In some embodiments, the processor may be configured to determine the first weight of the predicted distance at the current time and the second weight of the measured distance at the current time based on the prediction deviation corresponding to the predicted distance of the object to be detected at the current time and the measurement noise of the measured distance at the current time, where the first weight may be negatively correlated with the prediction deviation, and the second weight may be negatively correlated with the measurement noise; and perform a weighted summation based on the predicted distance and the first weight at the current time, and the measured distance and the second weight at the current time to determine the optimal estimated distance of the object to be detected at the current time.

In some embodiments, the processor may be configured to determine the predicted height of the object to be detected at the current time based on the speed of the object to be detected in the vertical direction and the optimal height of the object to be detected at the previous time; determine the prediction deviation corresponding to the predicted height at the current time based on the estimation deviation and process noise corresponding to the optimal estimated height at the previous time; and determine the first weight and the second weight based on the prediction deviation corresponding to the predicted height and the measurement noise at the current time.

An embodiment of the present disclosure further provides a distance determination system including a radar and a processor. The processor may be configured to obtain a plurality of reflection points within a predetermined angle range in a direction to be measured; coordinate the plurality of reflection points; perform function fitting on the plurality of coordinated reflection points; determine a measured distance of the object to be detected at the current time based on the function obtained by fitting; and weight the measured distance of the object to be detected at the current time and a predicted distance of the object to be detected at the current time to determine an optimal estimated distance of the object to be detected at the current time.

An embodiment of the present disclosure further provides a UAV, including the height determination system and/or the distance determination system described in any of the foregoing embodiments.

An embodiment of the present disclosure further provides a computer-readable storage medium. A number of computer instructions can be stored on the computer-readable storage medium. When executed by a processor, the computer instructions can cause the processor to obtain a plurality of reflection points within a predetermined angle range below an object to be detected; coordinate the plurality of reflection points; perform function fitting on the plurality of coordinated reflection points; determine a measured height of the object to be detected at a current time based on the function obtained by the fitting; and weight the measured height of the object to be detected at the current time and the predicted height of the object to be detected at the current time to determine an optimal estimated height of the object to be detected at the current time.

In some embodiments, the computer instructions can cause the processor to obtain a plurality of reflection points within a predetermined angle range below the object to be detected; determine an invalid point in the plurality of reflection points positioned outside a detection blind zone or a detection range; and delete the invalid point from the plurality of reflection points.

In some embodiments, the computer instructions can cause the processor to determine a ratio of the invalid points in the plurality of reflection points; delete the invalid points from the reflection points if the ratio is less than a predetermined ratio; and obtain the plurality of reflection points again if the ratio is greater than or equal to the predetermined ratio.

In some embodiments, the computer instructions can cause the processor to construct a rectangular coordinate system; obtain a plurality of detection distances and a plurality of detection angles of the plurality of reflection points; and calculate the coordinates of the reflection points in the coordinate system based on the plurality of detection distances and the plurality of detection angles

In some embodiments, the computer instructions can cause the processor to perform clustering processing on the plurality of reflection points before performing function fitting on the plurality of coordinated reflection points.

In some embodiments, the computer instructions can cause the processor to map the plurality of reflection points to non-zero elements in a 2D matrix; and delete the non-zero elements in the 2D matrix whose clustering density is lower than the predetermined density.

In some embodiments, the computer instructions can cause the processor to construct a 2D matrix; initialize the 2D matrix as an empty matrix; establish a mapping relationship between the elements of the 2D matrix and the coordinated reflection points; and set the elements of the 2D matrix having a mapping relationship with the plurality of reflection points as non-zero values.

In some embodiments, the computer instructions can cause the processor to traverse the 2D matrix with a sliding window; keep the elements in the sliding window unchanged when the number of non-zero elements in the sliding window is greater than or equal to a predetermined threshold; and set an anchor element of the sliding window to zero when the number of non-zero elements in the sliding window is less than the predetermined threshold.

In some embodiments, the computer instructions can cause the processor to determine a traversing starting point and/or a traversing end point in the non-zero elements; and use the traversing starting point as a starting anchor point, the traversing end point as an ending anchor point, and a single element as a traversing step, moving the sliding window in a row traversal or a column traversal manner.

In some embodiments, the computer instructions can cause the processor to determine an element with the smallest sum of rows and columns of the non-zero elements in the 2D matrix as the traversing starting point; or, determine the element with the smallest sum of the number of rows and columns of the non-zero elements in the 2D matrix as the traversing ending point.

In some embodiments, the computer instructions can cause the processor to determine an element with the largest sum of rows and columns of the non-zero elements in the 2D matrix as the traversing starting point; or, determine the element with the largest sum of the number of rows and columns of the non-zero elements in the 2D matrix as the traversing ending point.

In some embodiments, the computer instructions can cause the processor to map the non-zero elements in the 2D matrix to the reflection point coordinates based on the mapping relationship between the elements of the 2D matrix and the plurality of coordinated reflection points after deleting the non-zero elements in the 2D matrix whose clustering density is lower than the predetermined threshold.

In some embodiments, the computer instructions can cause the processor to construct a curve as an objective function; determine a slope and an intercept of the objective function based on the plurality of reflection points; and obtain the objective function based on the slope and the intercept.

In some embodiments, the computer instructions can cause the processor to determine the height of the object to be detected based on the distance from the origin in the coordinate system of the objective function to the object function

In some embodiments, the computer instructions can cause the processor to determine the first weight of the predicted height at the current time and the second weight of the measured height at the current time based on the prediction deviation corresponding to the predicted height of the object to be detected at the current time and the measurement noise of the measured height at the current time, where the first weight may be negatively correlated with the prediction deviation, and the second weight may be negatively correlated with the measurement noise; and perform a weighted summation based on the predicted height and the first weight at the current time, and the measured height at the current time and the second weight to determine the optimal estimated height of the object to be detected at the current time.

In some embodiments, the computer instructions can cause the processor to determine the predicted height of the object to be detected at the current time based on the speed of the object to be detected in the vertical direction and the optimal height of the object to be detected at the previous time; determine the prediction deviation corresponding to the predicted height at the current time based on the estimation deviation and process noise corresponding to the optimal estimated height at the previous time; and determine the first weight and the second weight based on the prediction deviation corresponding to the predicted height and the measurement noise at the current time.

An embodiment of the present disclosure further provides a computer-readable storage medium. A number of computer instructions can be stored on the computer-readable storage medium. When executed by a processor, the computer instructions can cause the processor to obtain a plurality of reflection points within a predetermined angle range in a direction to be measured; coordinate the plurality of reflection points; perform function fitting on the plurality of coordinated reflection points; determine a measured distance of the object to be detected at the current time based on the function obtained by fitting; and weight the measured distance of the object to be detected at the current time and a predicted distance of the object to be detected at the current time to determine an optimal estimated distance of the object to be detected at the current time.

An embodiment of the present disclosure further provides a height determination device. The height determination device may include a reflection point acquisition module configured to obtain a plurality of reflection points within a predetermined angle range below the object to be detected; a reflection point coordination module configured to coordinate the plurality of reflection points; a function fitting module configured to perform function fitting on the plurality of coordinated reflection points; a height measurement determination module configured to determine the measured height of the object to be detected at the current time based on the function obtained by fitting; and a height estimation determination module configured to weight the measured height of the object to be detected at the current time and the predicted height of the object to be detected at the current time to determine an optimal estimated height of the object to be detected at the current time.

An embodiment of the present disclosure further provides a distance determination device. The distance determination device may include a reflection point acquisition module configured to obtain a plurality of reflection points within a predetermined angle range below the object to be detected; a reflection point coordination module configured to coordinate the plurality of reflection points; a function fitting module configured to perform function fitting on the plurality of coordinated reflection points; and a distance estimation determination module configured to weight the measured distance of the object to be detected at the current time and the predicted distance of the object to be detected at the current time to determine the optimal estimated distance of the object to be detected at the current time.

With regard to the apparatuses in the above-described embodiments, the detailed methods in which each module performs the operations have been described in detail in the method embodiments, and will not repeated here.

The system, device, module or unit illustrated in the above embodiments may be implemented by a computer chip or an entity, or by a product having a certain function. For the convenience of description, the above devices are described separately by function into various units. The functions of each unit may be implemented in one or more software and/or hardware when implementing the present application. Those skilled in the art will appreciate that embodiments of the present disclosure can be provided as a method, system, or computer program product. Accordingly, the present disclosure may take the form of an entirely hardware embodiment, an entirely software embodiment, or a combination of software and hardware. Moreover, the disclosure can take the form of a computer program product embodied on one or more computer-executable storage media (including but not limited to disk storage, CD-ROM, optical storage, etc.) including computer readable program code. The computer readable program code can be executed by a process consistent with the disclosure to perform a method consistent with the disclosure, such as one of the example methods described above.

The various embodiments in the specification are described in a progressive manner, and the same or similar parts between the various embodiments may be referred to each other, and each embodiment focuses on the differences from the other embodiments. In particular, for the system embodiment, since it is basically similar to the method embodiment, the description is relatively simple, and the relevant parts can be referred to the description of the method embodiment.

It should be noted that, in this context, relational terms, such as first, second, etc., are used merely to distinguish one entity or operation from another entity or operation, and do not necessarily require or imply there is any such actual relationship or order between these entities or operations. The terms “comprising,” “including,” or other variation are intended to include a non-exclusive inclusion, such that a process, method, article, or device that includes a plurality of elements includes not only those elements, but also other elements not specifically listed, or elements that are inherent to such a process, method, article, or device. An element that is defined by the phrase “comprising a . . . ” does not exclude the presence of additional equivalent elements in the process, method, article, or device that includes the element.

The above description is only an embodiment of the present application and is not intended to limit the application. Various changes and modifications can be made to the present application by those skilled in the art. Any modifications, equivalents, improvements, etc. made within the spirit and scope of the present application are intended to be included within the scope of the appended claims.

What is claimed is:

1. A method for determining height, comprising:
obtaining a plurality of reflection points within a predetermined angle range below an object to be detected;
coordinating the plurality of reflection points;
performing function fitting on the plurality of coordinated reflection points;
determining a measured height of the object to be detected at a current time based on a function obtained by fitting; and
weighting the measured height of the object to be detected at the current time and a predicted height of the object to be detected at the current time to determine an optimal estimated height of the object to be detected at the current time.

2. The method of claim 1, wherein obtaining the plurality of reflection points within the predetermined angle range below the object to be detected includes:
obtaining the plurality of reflection points within the predetermined angle range below the object to be detected;
determining a plurality of invalid points in the plurality of reflection points positioned in a detection blind zone or outside a detection range;
deleting the plurality of invalid points from the plurality of reflection points.

3. The method of claim 2, wherein after determining the plurality of invalid points in the plurality of reflection points positioned in the detection blind zone or outside the detection range, further comprising:
determining a ratio of the plurality of invalid points in the plurality of reflection points;
deleting the plurality of invalid points if the ratio is less than a predetermined ratio; and
obtaining the plurality of reflection points again if the ratio is greater than or equal to predetermined ratio.

4. The method of claim 1, wherein coordinating the plurality of reflection points includes:
constructing a rectangular coordinate system;
obtaining a plurality of detection distances and a plurality of detection angles of the plurality of reflection points; and
calculating the coordinates of the plurality of reflection points in the coordinate system based on the plurality of detection distances and the plurality of detection angles.

5. The method of claim 4, further comprising:
performing clustering processing on the plurality of reflection points before performing function fitting on the plurality of coordinated reflection points.

6. The method of claim 5, wherein performing clustering processing on the plurality of reflection points includes:
mapping the plurality of reflection points to a plurality of non-zero elements in a two-dimensional (2D) matrix; and
deleting the plurality of non-zero elements in the 2D matrix whose clustering density is lower than a predetermined density.

7. The method of claim 6, wherein mapping the plurality of reflection points to the plurality of non-zero elements in the 2D matrix includes:
constructing the 2D matrix;
initializing the 2D matrix as an empty matrix;
establishing a mapping relationship between the elements of the 2D matrix and the plurality of coordinated reflection points; and
setting the elements of the 2D matrix having the mapping relationship with the plurality of reflection points to non-zero values.

8. The method of claim 6, wherein deleting the plurality of non-zero elements in the 2D matrix whose clustering density is lower than the predetermined density includes:
using a sliding window to traverse the 2D matrix;
keeping the elements in the sliding window unchanged when a number of non-zero elements in the sliding window is greater than or equal to a predetermined threshold; and
setting an anchor element of the sliding window to zero when the number of non-zero elements in the sliding window is less than the predetermined threshold.

9. The method of claim 8, wherein using the sliding window to traverse the 2D matrix includes:
determining a traversing starting point and/or a traversing ending point in the non-zero elements; and
using the traversing starting point as a starting anchor point, the traversing ending point as an ending anchor point, and a single element as a traversing step to move the sliding window in a row traversing or a column traversing manner.

10. The method of 8, wherein determining the traversing starting point and/or the traversing ending point in the non-zero elements includes:
determining an element with a smallest sum of rows and columns of the non-zero elements in the 2D matrix as the traversing starting point; or, determining the element with the smallest sum of rows and columns of the non-zero elements in the 2D matrix as the traversing ending point.

11. The method of claim 8, wherein determining the traversing starting point and/or the traversing ending point in the non-zero elements includes:
determining an element with a largest sum of rows and columns of the non-zero elements in the 2D matrix as the traversing starting point; or, determining the element with the largest sum of rows and columns of the non-zero elements in the 2D matrix as the traversing ending point.

12. The method of claim 6, wherein after deleting the plurality of non-zero elements whose clustering density is lower than the predetermined density in the 2D matrix, further comprising:
mapping the non-zero elements in the 2D matrix to the reflection point coordinates; based on the mapping relationship between the elements of the 2D matrix and the plurality of coordinated reflection points.

13. The method of claim 1, wherein performing function fitting of the plurality of coordinated reflection points includes:
constructing a curve as an objective function;
determining a slope and an intercept of the objective function based on the plurality of reflection points; and
determining the objective function based on the slop and the intercept.

14. The method of claim 13, wherein determining the measured height of the object to be detected at the current time based on the function obtained by fitting includes:
determining a height of the object to be detected based on a distance from an origin in the coordinate system where the objective function is positioned to the objective function.

15. The method of claim 1, wherein weighting the measured height of the object to be detected at the current time and the predicted height of the object to be detected at the current time to determine the optimal estimated height of the object to be detected at the current time includes:
determining a first weight of the predicted height at the current time and a second weight of the measured height at the current time based on a prediction deviation corresponding to the predicted height of the object to be detected at the current time and a measurement noise of the measured height at the current time, the first weight being negatively correlated with the prediction deviation, and the second weight being negatively correlated with the measurement noise; and
performing a weighted summation based on the predicted height and the first weight at the current time, and the measured height at the current time and the second weight to determine the optimal estimated height of the object to be detected at the current time.

16. The method of claim 15, wherein determining the first weight of the predicted height at the current time and the second weight of the measured height at the current time based on the prediction deviation corresponding to the predicted height of the object to be detected at the current time and the measurement noise of the measured height at the current time includes:
determining the predicted height of the object to be detected at the current time based on a speed of the object to be detected in a vertical direction and the optimal height of the object to be detected at a previous time;
determining the prediction deviation corresponding to the predicted height at the current time based on an estimation deviation and a process noise corresponding to the optimal estimated height at the previous time; and
determining the first weight and the second weight based on the prediction deviation corresponding to the predicted height and the measurement noise at the current time.

17. A height determination system, comprising:
a radar and a processor, wherein the processor is configured to:
obtain a plurality of reflection points within a predetermined angle range;
coordinate the plurality of reflection points;
perform function fitting on the plurality of coordinated reflection points;
determine a measured height of an object to be detected at a current time based on a function obtained by fitting; and
weight the measured height of the object to be detected at the current time and a predicted height of the object to be detected at the current time to determine an optimal estimated height of the object to be detected at the current time.

18. The system of claim 17, wherein the processor is configured to:
obtain the plurality of reflection points within the predetermined angle range below the object to be detected;
determine a plurality of invalid points in the plurality of reflection points positioned in a detection blind zone or outside a detection range; and
delete the plurality of invalid points from the plurality of reflection points.

19. The system of claim 18, wherein the processor is configured to:
determine a ratio of the plurality of invalid points in the plurality of reflection points;
delete the plurality of invalid points if the ratio is less than a predetermined ratio; and
obtain the plurality of reflection points again if the ratio is greater than or equal to the predetermined ratio.

20. A distance determination system, comprising:
a radar and a processor, wherein the processor is configured to:
obtain a plurality of reflection points within a predetermined angle range in a direction to be measured;
coordinate the plurality of reflection points;
perform function fitting on the plurality of coordinated reflection points;
determine a measured distance of an object to be detected at a current time based on a function generated by fitting; and
weight the measured distance of the object to be detected at the current time and a predicted distance of the object to be detected at the current time to determine an optimal estimated distance of the object to be detected at the current time.
